(19) United States
(12) Patent Application Publication
(10) Pub. No.: US 2010/0051752 A1
(43) Pub. Date: Mar. 4, 2010

(54) Aerodynamic or Hydrodynamic Profile Which Can Be Deformed in a Continuous and Controlled Manner

(76) Inventors: Georges Meyer, Riedisheim (FR); Fabrice Laurent, Leimbach (FR); Cedric Maupoint, Bergholtz (FR); Herve Drobez, Mulhouse (FR); Gildas L'Hostis, Rixheim (FR); Bernard Durand, Pfastatt (FR)

Correspondence Address: THE WATSON INTELLECTUAL PROPERTY GROUP, PLC, 3133 HIGHLAND DRIVE, SUITE 200, HUDSONVILLE, MI, 49426, US

(21) Appl. No.: 12/225,828

(22) PCT Filed: Mar. 1, 2007
(86) PCT No.: PCT/FR2007/050866

§ 371 Date: Nov. 12, 2009

(30) Foreign Application Priority Data
Mar. 27, 2006 (FR) 0651048

(51) Int. Cl. B64C 3/48

(52) U.S. Cl. 244/219

(57) ABSTRACT

The present invention relates to an aerodynamic or hydrodynamic profile (1) which can be deformed in a continuous and controlled manner, essentially consisting of a shell mounted on an infrastructure. The profile is characterized in that said infrastructure comprises a core (2) extending along the longitudinal axis of the cross section of the profile (1), and in that this core (2) has at least one active section made of composite material having continuous and controlled deformation under the effect of an adjustable temperature variation in at least one active layer of said composite material which, in the regions of the shell of the profile (1) corresponding to said active section, induces a deformation of corresponding direction and amplitude.

The present invention concerns the field of aerodynamic or hydrodynamic profiles, and in particular the field of profiles capable of deforming to adapt their shape to the operating conditions, so as to obtain a specific trajectory or a better penetration in the fluid, for example. This fluid may, of course, be in the gas, vapor, or liquid state.

More specifically, the invention concerns an aerodynamic or hydrodynamic profile that can be deformed in a continuous and controlled manner.

There are many types of profiles whose shape can be modified. Thus the document EP 0 958 999 describes an aerodynamic profile whose trailing edge can pivot around an axis by means of a linear mechanical actuator. But this type of actuator has the disadvantage of being cumbersome, large, and relatively heavy, so that its installation is not easy or optimal in thin and/or light profiles.

The document WO 2004/069651 describes an aerodynamic profile that can be deformed by means of piezoelectric actuators. But this type of actuator does not make it possible to achieve large movements or significant deformations and often requires the integration of a mechanical amplifier, which results in the need for an energy input and a structure that is heavier, bulkier, and also more expensive.

There are also devices using shape memory alloys as actuators making it possible to move flaps on aerodynamic profiles. But these devices are not progressive, that is, they do not make it possible to achieve a progressive and reversible movement or deformation.

The goal of the invention is to solve the above problems, and more specifically to provide an aerodynamic or hydrodynamic profile or section that can be deformed in a continuous and controlled manner and has a simple and light structure. In addition, the profile should consume a small amount of energy. Additionally, the profile should also have a totally airtight outer surface or shell whose outer wall does not form a fold when the profile is deformed.

For this purpose, the object of the invention is an aerodynamic or hydrodynamic profile that can be deformed in a continuous and controlled manner, essentially consisting of a shell mounted on an infrastructure, characterized by the fact that the infrastructure has a core extending along the longitudinal axis of the profile cross section, and by the fact that this core has at least one active section made of composite material having continuous and controlled deformation under the effect of an adjustable temperature variation in at least one active layer of the composite material, which, in the regions of the shell of the profile corresponding to the active section, induces a deformation of corresponding direction and amplitude.

The invention will be better understood thanks to the description that follows, which refers to a preferred embodiment given as a non-limiting example and explained with reference to the attached schematic drawings, in which:

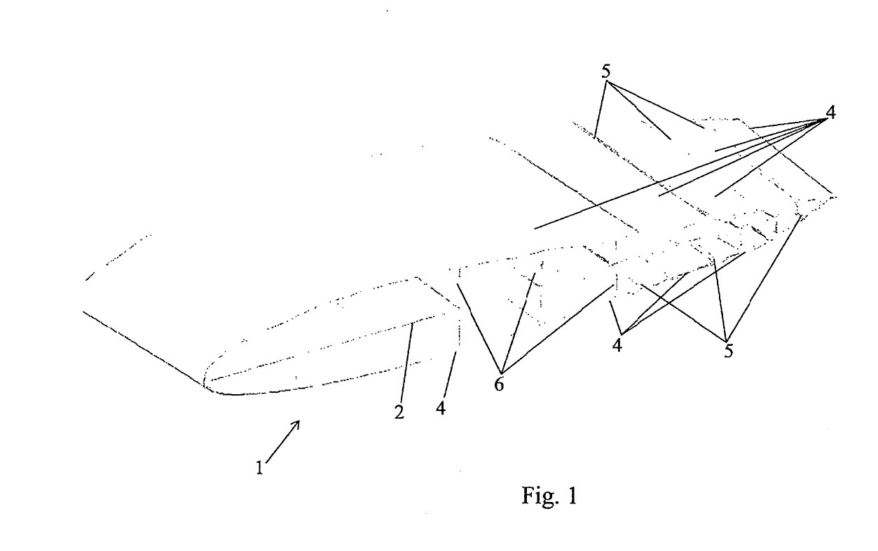

FIG. 1 is a schematic perspective view of a profile according to the invention;

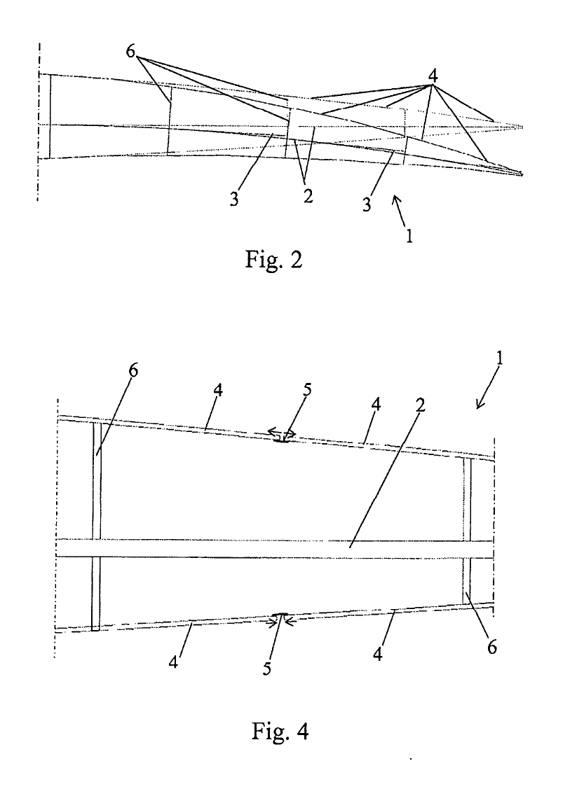

FIG. 2 is a sectional view of the geometry of a profile according to the invention in the undeformed and deformed state;

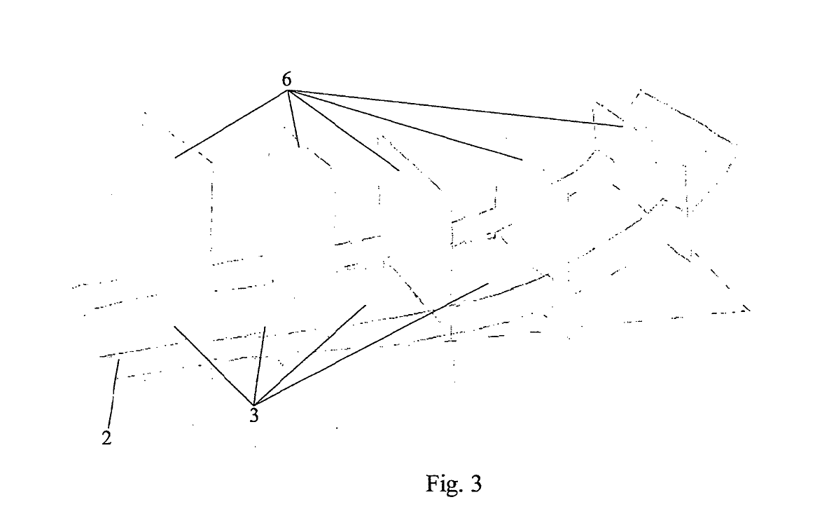

FIG. 3 is a partial cutaway view showing a profile equipped with locking devices in the deformed state; and

FIG. 4 is a sectional view of a detail of the shell of the profile according to the invention.

FIGS. 1 to 4 of the attached drawings show an aerodynamic or hydrodynamic profile 1 according to the invention that can be deformed in a continuous and controlled manner, essentially consisting of a shell mounted on an infrastructure. It characterized by the fact that the infrastructure has a core 2 extending along the longitudinal axis of the cross section of the profile 1, and this core 2 has at least one active section made of composite material having continuous and controlled deformation under the effect of an adjustable temperature variation in at least one active layer of the composite material, which, in the regions of the shell of the profile 1 corresponding to the active section, induces a deformation of corresponding direction and amplitude.

Thanks to the invention, it is possible to make a profile 1 whose deformation is simultaneously targeted to the regions of its shell that are located at the level of an active section. This has the advantage of very easy adjustment of such a profile 1 as a function of its use and the conditions of this use.

The active regions located at the level of the core 2 of the profile 1 are used to deform this latter. The fact of positioning these active regions on the core 2 makes it possible to isolate these latter from surrounding thermal disturbances, so that they are subject only to the effects of a controlled temperature variation.

These active regions may have a structure identical to that of the composite material described in the French patent application No. 04 02163 in the name of the applicant. They may, for example, be laminated.

The composite material can be the multi-layered type and may consist of resins and fibers.

According to the invention, each active section of the core 2 may have at least one inactive layer having expansion characteristics different from those of the active layer or layers of the active section in question. The use of materials having different expansion characteristics makes it possible to achieve deformation of the active region, the core 2, and therefore the profile 1.

Depending on the materials used to make the active regions and depending on their coefficient of expansion, it is possible to connect at least one active section of the core 2 to a heating source or a cooling source. Of course, in the case where the profile 1 has a number of active regions, these latter can all be connected to a heating source or all connected to a cooling source, or else some of them can be connected to a heating source and the others to a cooling source. It is also possible to connect one or more active sections of the core 2 to both a heating source and a cooling source, so as to achieve a finer and faster adjustment of the deformation.

The active sections of the core 2 can be connected to a source without a physical connector. It is thus possible, for example, to activate an active section using waves, for example high-frequency waves like microwaves.

In the case of a physical connector, it is possible to use one or more conductive active layers made of an electrically conductive material and connected by wires to one or more adjustable-power electrical sources, whereby the inactive layer or layers can be made of a non-electrically conductive but thermally conductive material.

With respect to the cooling source or sources, these can, for example, be in the form of one or more nozzles spraying a flow of air in the direction of one or more active sections of the core 2.

In both cases, this source can be controlled by a control device taking into account a certain number of variables, such as the pressure exerted on the profile 1, its orientation, or the trajectory to follow, in order to control the source so that it causes a temperature variation corresponding to the desired deformation of the profile 1. Thus the profile 1 is made intelligent and automatically adjusts its shape.

According to one advantage of the invention and as shown schematically in FIG. 3, the profile 1 may have a device 3 for locking its deformed position, so that there is a savings in the energy necessary to keep the profile 1 in its deformed state and operating costs are relatively low. In other words, this locking device 3 makes it possible to fix the profile 1 in a deformed position without supplying power to the active regions.

This locking device 3 may be the type that automatically and continuously locks during the deformation of the profile 1 and can be unlocked by an actuating device.

Thus in order to deform a profile 1 according to the invention, it is first of all necessary to vary the temperature of the active layer or layers of the active region or regions of the core 2. As the profile 1 deforms, the locking device 3 assumes different locking positions. When the profile 1 has reached the desired deformation and its deformation is stopped, it is kept in this state of deformation by the locking device 3. At this stage it is therefore no longer necessary to maintain the power supply or activation of the active layer or layers in order for the profile 1 to keep this position.

When the profile 1 has active layers capable of deforming in two directions, it is preferable to equip the profile 1 with two locking devices 3, each of which is then designed to lock the profile 1 during deformation in one of the two directions.

According to an embodiment of the invention not shown, the invention is characterized by the fact that the locking device 3 may comprise a rack engaging with the teeth of a toothed free wheel. Thus as the profile 1 is deformed, another tooth is engaged and the corresponding deformed position is locked.

According to another variant not shown, the locking device 3 may comprise a ratchet wheel and a catch.

According to the invention, the actuating device may be an active section made of a composite material having continuous and controlled deformation under the effect of an adjustable temperature variation in at least one active layer of the composite material, whereby the active section induces a controlled deformation of the locking device 3 as a function of the temperature variation, driving this latter out of its locking position into another locking position or into its unlocked position.

By controlling the rate of deformation of the actuating device, it is therefore also possible to control the return to the initial or undeformed position of the profile 1 or its return to an intermediate position.

As a variant, the actuating device may be made from traditional active materials such as shape memory alloys or piezoelectric or magnetostrictive elements.

In all cases, the rigidity of the locking devices 3 should be designed to withstand the stresses generated by the blocking and friction of the core 2.

According to a characteristic of the invention shown in FIG. 4, the shell of the profile 1 may be covered by a number of skins 4 placed side by side, whereby a seal 5 is located at the interfaces between these skins 4, under these latter. This seal 5 can advantageously be in the form of an elastically deformable prestressed membrane. Such a device makes it possible to improve and amplify the deformation of the profile 1, while allowing the skins 4 to slide with respect to each other and guaranteeing that the profile is airtight.

In order to solve the problems of the stresses due to deformation of the profile 1 (tensile stress on the upper surface, compressive stress on the lower surface), the infrastructure may consist of support pieces 6 mounted perpendicular to the core 2, on this latter and on either side of this latter and extending to the shell of the profile 1, and the skins 4 are each placed between two consecutive support pieces 6.

The spacing between two skins 4 may be about one millimeter, which represents a small distance with respect to the profile 1 and therefore does not have the effect of disturbing the flow of the fluid over the profile 1. In addition, the seals ensure that things are airtight.

The core 2 together with the support pieces 6 thus serves as a skeleton. The number of support pieces 6 is determined during the design phase and varies as a function of the operating conditions (size of the structure, flow rate, and anticipated flying altitudes in the case of a wing).

The general profile 1 and the dimensions of the wing are variable. They are associated with the aerodynamic properties and the main structure.

Thanks to the invention, it is possible to make a profile 1 whose shape or geometry can be modified to adjust to the operating conditions: speed, nature of flow, etc.

In the field of aeronautics, existing mechanisms such as the pivoting and retractable flaps found on the trailing edge of airplane wings can thus be eliminated, and it is no longer necessary to install mechanisms with controls, hydraulic systems, or motors in the profiles 1 to ensure their deformation, so that a simplified and light structure is obtained.

This type of profile 1 according to the invention with a light and deformable structure can be used for the wings of drones, that is, unmanned aircraft that must be capable of flying at low speed while remaining inconspicuous. It could also pertain to standard civilian or military airplanes in the context of looking for increasingly lighter structures.

Such a profile 1 can also be used to make a wing whose deformation makes it possible to vary the coefficient of pressure Cₚ on the lower and upper surfaces. It is verified by calculation that the pressures on the trailing edge are low relative to the forces generated by the deformation of the active core 2. This means that the wing has sufficient resistance to resist external pressure fluctuations.

Thus as shown in FIG. 2, with an active layer 450 mm long (about half the profile 1), tests showed that it is possible to obtain a deflection of 40 to 45 mm at the tip. Calculations make it possible to determine the optimum composition of the laminate in order to obtain the maximum deflection for a power of 2.5 kW/m² for 2 minutes.

The profile 1 according to the invention can of course concern a wing or a blade that can be integrated into any aeronautic or hydraulic structure (airplane, shuttle, drone, flying structure, windmill blade, turbine blade, helicopter blade).

Of course the invention is not limited to the embodiment described and shown in the attached drawings. Modifications are possible, in particular from the standpoint of the composition of the various elements or by substitution of equivalent techniques, without leaving the scope of protection of the invention.

1. Aerodynamic or hydrodynamic profile that can be deformed in a continuous and controlled manner, essentially consisting of a shell mounted on an infrastructure, characterized by the fact that the infrastructure has a core (2) extending along the longitudinal axis of the cross section of the profile (1), and by the fact that this core (2) has at least one active section made of composite material having continuous and controlled deformation under the effect of an adjustable temperature variation in at least one active layer of the composite material, which, in the regions of the shell of the profile (1) corresponding to the active section, induces a deformation of corresponding direction and amplitude.

2. Profile according to claim 1, characterized by the fact that each active section of the core (2) has at least one inactive layer having expansion characteristics different form those of the active layer or layers of the active section in question.

3. Profile according to claim 1, characterized by the fact that at least one active section of the core (2) is connected to a heating source.

4. Profile according to claim 1, characterized by the fact that at least one active section of the core (2) is connected to a cooling source.

5. Profile according to claim 1, characterized by the fact that it has a device (3) for locking the deformed position of the profile (1).

6. Profile according to claim 5, characterized by the fact that the locking device (3) is the type that automatically and continuously locks during the deformation of the profile (1) and can be unlocked by an actuating device.

7. Profile according to claim 6, characterized by the fact that the locking device (3) comprises a rack engaging the teeth of a toothed free wheel.

8. Profile according to claim 6, characterized by the fact that the locking device (3) comprises a ratchet wheel and a catch.

9. Profile according to claim 6, characterized by the fact that the actuating device is an active section made of a composite material having continuous and controlled deformation under the effect of an adjustable temperature variation in at least one active layer of the composite material, whereby the active section induces a controlled deformation of the locking device (3) as a function of the temperature variation, driving this latter out of its locking position into another locking position or into its unlocked position.

10. Profile according to claim 1, characterized by the fact that the shell of the profile (1) is covered by a number of skins (4) placed side by side, whereby a seal (5) is located at the interfaces between these skins (4), under these latter.

11. Profile according to claim 10, characterized by the fact that the infrastructure consists of support pieces (6) mounted perpendicular to the core (2), on this latter and on either side of this latter and extending to the shell of the profile (1), and by the fact that the skins (4) are each placed between two consecutive support pieces (6).
